(19) United States
(12) Patent Application Publication
(10) Pub. No.: US 2008/0042458 A1
(43) Pub. Date: Feb. 21, 2008

(54) Two-handed shovel

(76) Inventor: Robin Edward Ricket, Gurnee, IL (US)

Correspondence Address: MICHAEL RIES, 318 PARKER PLACE, OSWEGO, IL, 60543, US

(21) Appl. No.: 11/504,371

(22) Filed: Aug. 15, 2006

(51) Int. Cl. A01B 1/22

(52) U.S. Cl. 294/58

(57) ABSTRACT

A device with two handles and a blade a first handle that connects to the blade and a second handle that attaches to the blade at a permanent connection point in front of a load. A process for shoveling snow or moving material that lifts the material, load or snow by simultaneously exerting upward forces on the first handle and the second handle while the load is between the two handles with a load force in the opposite direction.

### TECHNICAL FIELD & BACKGROUND

The present invention generally relates to shovels. More specifically, the present invention relates to shovels with a second stand up handle.

There is a constant search in the winter tools and shoveling industries to find ways to make shoveling easier. The present invention reduces lead-hand load resulting in reduced risk of injury during lifting and throwing motions. Shoveling is accomplished in a sweeping motion which both collects and lifts the snow onto the blade. After the load is in the blade the user will lift and twist their torso to throw the load to a new location. In the present invention the dual handle arrangement will substantially reduce the twisting motion and decrease user load due to the load placement between the two handles.

Problems occur when people try to shovel snow that is too heavy for them. People will twist their spine and shoulders in an effort to assist them in shoveling heavy loads and overexert themselves risking heart attacks and possible other muscle or soft tissue injury. Other types of shovels use different methods such as an auxiliary handle connected to the primary handle. They have not used a second handle connected to the front of the blade in front of the load, creating a mechanical advantage with the primary handle on the other side of the load. The present invention amplifies the force which reduces the effort required to lift and throw snow. Shoveling can be accomplished with less exertion and decreased risk of injury.

### BRIEF DESCRIPTION OF THE DRAWINGS

FIG. 1 is a drawing of a side view of a user using a shovel, in accordance with one embodiment of the present invention;

FIG. 2A is a drawing of a perspective view of the shovel with a connection point at a blade, in accordance with one embodiment of the present invention;

FIG. 2B is a drawing of a perspective view of the shovel with a connection point at sides of a blade having a U shaped frame, in accordance with one embodiment of the present invention;

FIG. 3A is a drawing of the basis for operation of the shovel with forces indicated, in accordance with one embodiment of the present invention; and

FIG. 3B is a drawing of the shovel demonstrating the forces on the shovel, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

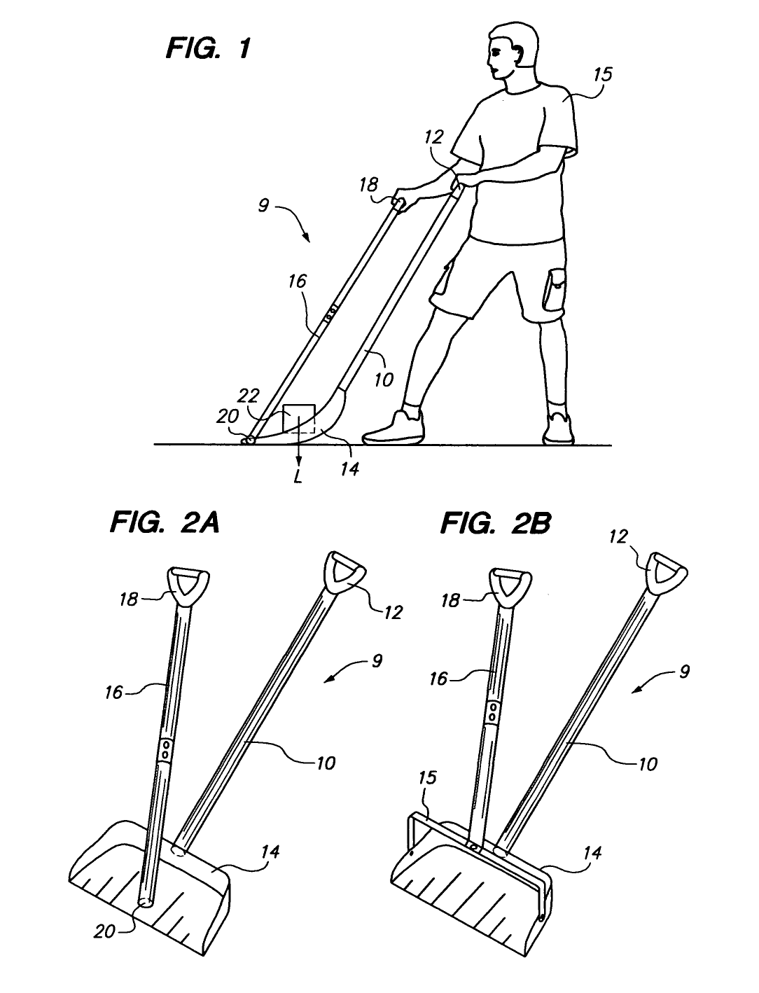

Referring now to FIG. 1, in one embodiment illustrated is a two-handed shovel or shoveling device and user 15. The primary handle 10 has a grip 12 on one end and the other end is connected to a blade 14. The auxiliary handle 16 has an elongated grip 18 on one end and the other end is attached to the front of the blade 14 at attachment point or connection point 20. The blade 14 enters a snow pile, pushing snow or a load 22 onto the back of the blade 14 behind the connection point 20. With the snow or load 22 behind connection point 20 both the primary handle 10 and auxiliary handle 16 reduce the effort needed by user 15 to lift and throw the snow or load 22 reducing back strain and possible other injuries when the user 15 moves a load L.

Referring to FIG. 2A, illustrated is one embodiment that is a perspective view of the present invention. The auxiliary handle 16 is attached to the front of the blade 14 at a point called the connection point 20. The connection point 20 can be attached by a pin, ball joint, U joint or any appropriate mechanical fastener or adhesive. In FIG. 2B, as in one embodiment of the shovel 9 that may be fabricated to have the auxiliary handle 16 of variable length for different heights of users 15. An auxiliary frame 15 may be hingeably connected to blade 14 at the blade sides. In one embodiment, the primary handle may be slightly curved for different ergonomics involving a smooth swing that maintains the natural curve of the spine.

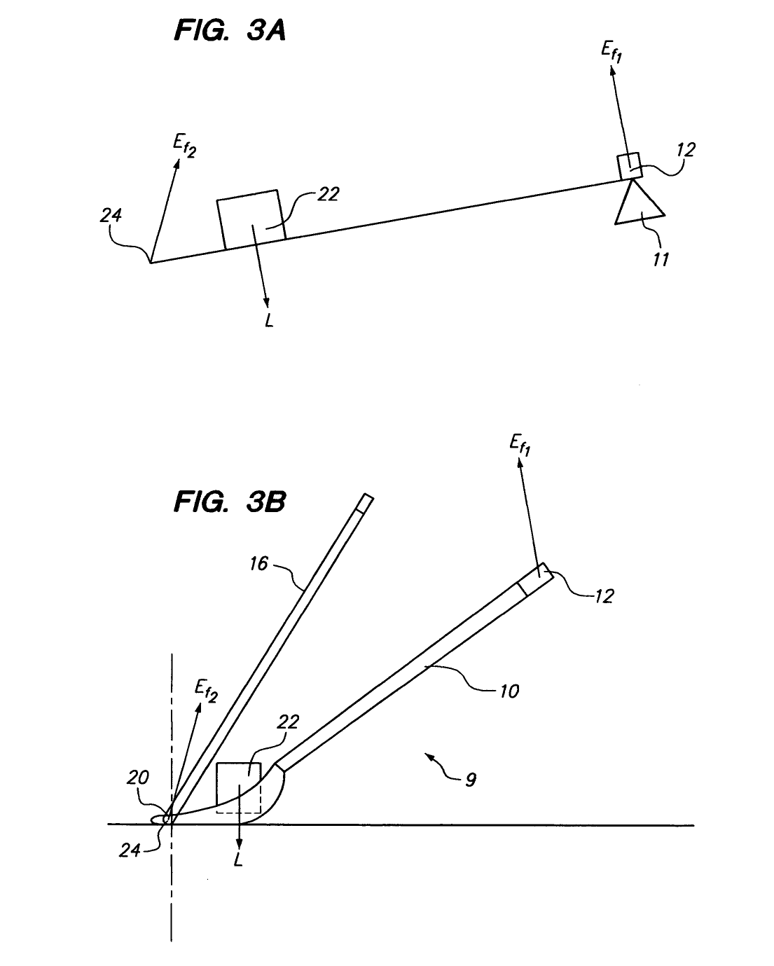

Referring to FIG. 3A, illustrated as in one embodiment is a diagram of the present invention with forces shown. The load 22 with load force L is disposed between the connection point 24 and the grip 12 the grip 12 may be a fulcrum 11 during all or some of the shoveling motion. A first exerted force Ef1 and a second exerted force Ef2 are generally in the opposite direction of the load L force. Referring to FIG. 3B, illustrated as in one embodiment is a side view of the shoveling device 9. Attachment 24 may be a pin or nut and bolt connecting the auxiliary handle 16 to the blade 14. The first exerted force Ef1 is on the primary grip 12. The load 22 with load L force is between the connection point 20 and the primary grip 12. The connection point 20 occurs where the second handle 16 is attached to the blade 14 by a fastening device or attachment 24. The first exerted force Ef1 may be a value of zero so that the primary grip 12 acts like fulcrum 11 for part or all of the shoveling motion. Shoveling devices can take several forms in the present invention. For example, the shovel 9 may be simply a first handle, blade and second handle connected to the front of the blade. One embodiment of the shoveling device would allow for retractable handles for both the primary and secondary handle. The shovel would still have the key components of the primary grip being distal to the snow, while the attachment of the blade to the second handle must be in front of the load, even with the retractability of either or both handles.

Thus, it can be seen from the above descriptions, a shovel device having a primary handle and grip, a blade with a second handle connected to the front of the blade and a process for shoveling, including a shoveling motion to both collect and lift snow off of the blade of the shovel device. While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A device comprising:
a first handle;
a blade attached to the first handle; and
a second handle attached to the blade in front of a load.

2. The device according to claim 1, wherein the primary handle would have a grip at the distal end from the blade.

3. The device according to claim 1, wherein the second handle is rotatably and hingeabley attached to the blade.

4. The device according to claim 1, wherein a load is disposed between the connection point and the primary handle.

5. The device according to claim 1, wherein the second handle is elongated and comprises a grip on the end distal to the blade.

6. The device according to claim 1, wherein a second frame is pivotally attached to a second handle on one end and the other end is pivotally attached to the front of the blade.

7. The device according to claim 6, wherein the second frame is attached to the second handle using a pin.

8. The device according to claim 6, wherein the second frame is fixably attached to the blade.

9. The device according to claim 6, wherein the second frame has a bore where the second handle can screw into the bore to be attached to the frame.

10. A shovel comprising:
a blade;
a first handle attached to said blade on one end and a grip on the other end; and
a second elongated handle attached to a frame in front of a load the frame connects to the blade at a first and second side of the blade.

11. The shovel according to claim 10, wherein the load is disposed proximal and behind the connection point between the frame and the blade.

12. A process for shoveling comprising:
grabbing a first handle with one hand;
moving a second handle attached to the blade with a second hand;
receiving a load with a blade attached to the first handle and the second handle; and
lifting and throwing the load.

13. The process according to claim 12, wherein the receiving is scoping and the load is snow.

14. The process according to claim 12, wherein the second handle is attached to the blade at a connection point.

15. The process according to claim 12, wherein the receiving is shoveling that puts snow on the blade behind a connection point.

16. The process according to claim 12, wherein the lifting and throwing occurs with the load between a connection point and the first handle.

17. The process according to claim 12, wherein lifting and throwing using the second handle about a connection point reduces the force of pushing the first handle.

18. The process according to claim 12, wherein the second handle is pivotally connected to the blade.

19. The process according to claim 12, wherein the grabbing the first handle with a first hand is holding the first handle stationary.

20. The process according to claim 12, wherein the grabbing the first handle with the first hand is moving the first handle to lift and throw the load.
